(19) United States
(12) Patent Application Publication
(10) Pub. No.: US 2015/0308616 A1
(43) Pub. Date: Oct. 29, 2015

(54) Magnetic Hanging Device

(71) Applicant: Jill Abbott, Virginia Beach, VA (US)

(72) Inventor: Jill Abbott, Virginia Beach, VA (US)

(21) Appl. No.: 14/699,507

(22) Filed: Apr. 29, 2015

Related U.S. Application Data
(60) Provisional application No. 61/985,558, filed on Apr. 29, 2014.

(51) Int. Cl. F16M 13/02; F16B 1/00

(52) U.S. Cl. CPC F16M 13/022; F16B 1/00; F16B 2001/0035

(57) ABSTRACT

A magnetic hanging device that can be movably positioned on various surfaces and objects for supporting items thereon. The magnetic hanging device includes an elongated rod having a curved configuration, wherein each end of the elongated rod includes a magnet thereon. The elongated rod preferably has a U-shape such that the magnets can simultaneously engage a flat surface. The magnetic hanging device can be secured to any of various metal surfaces and objects such as tools can be suspended on the elongated rod of the hanging device. The hanging device further includes a corrosion resistant coating so that the device is suitable for outdoor use.

### CROSS REFERENCE TO RELATED APPLICATION

This application claims the benefit of U.S. Provisional Application No. 61/985,558 filed on Apr. 29, 2014. The above identified patent application is herein incorporated by reference in its entirety to provide continuity of disclosure.

### BACKGROUND OF THE INVENTION

1. Field of the Invention

The present invention relates to magnetic hanging devices. More specifically, the present invention provides a magnetic hanging device comprising an elongated rod having a U-shape configuration, wherein each end of the elongated rod includes a magnet thereon that can be removably secured to a support surface. Various objects can be suspended from the elongated rod of the magnetic hanging device.

Hanging devices are often used to suspend various objects, such as tools, in a convenient and easily accessible manner. However, in order to install a hanging device, such as a hook, it is necessary to drill a hole in a wall or other surface to secure the hanging device in position. This can be undesirable as the user must drill a hole in the wall, permanently damaging the wall. Alternatively, adhesives may be used to suspending hanging devices, but adhesives may not be sufficiently strong to hold a heavy object, and adhesive residue may be difficult to remove from the wall when the hanging device is removed. Providing hanging devices on metal objects presents additional challenges as it is difficult to create a hole in a metal surface for securing the hanging device thereon. Thus, a hanging device that can be removably secured to various objects and surfaces is desired.

Devices have been disclosed in the prior art that relate to hanging devices. These include devices that have been patented and published in patent application publications. The devices in the prior art generally relate to magnetic fasteners comprising a strap or belt with magnetic fastening members, such as U.S. Pat. No. 8,261,416, U.S. Pat. No. 6,301,754, U.S. Patent Application Publication Number 2011/0133528, U.S. Patent Application Publication Number 2012/0180197, and U.S. Pat. No. 3,102,314.

These prior art devices have several known drawbacks. The devices in the prior art relate to straps or fasteners having magnetic closures, and do not provide a magnetic hanging device having a rigid or semi-rigid elongated rod with a magnet on each end thereof. Further, such devices fail to provide a rigid or semi-rigid elongated rod that serves as a support on which various objects or tools can be suspended. The devices of the prior art are not suitable for suspending various tools or objects thereon.

In light of the devices disclosed in the prior art, it is submitted that the present invention substantially diverges in design elements from the prior art and consequently it is clear that there is a need in the art for an improvement to existing magnetic holding devices. In this regard the instant invention substantially fulfills these needs.

### SUMMARY OF THE INVENTION

In view of the foregoing disadvantages inherent in the known types of hanging devices now present in the prior art, the present invention provides a new magnetic hanging device wherein the same can be utilized for providing convenience for the user when providing a hanging device removably securable to a metal surface or object in order to allow a user to suspend one or more objects therefrom for convenient access.

It is therefore an object of the present invention to provide a new and improved magnetic hanging device that has all of the advantages of the prior art and none of the disadvantages.

It is another object of the present invention to provide a magnetic hanging device comprising an elongated rod having a magnet on each end thereof for securement to a metallic support surface.

Another object of the present invention is to provide a magnetic hanging device comprising a U-shaped elongated rod on which any of various objects or tools can be suspended.

Yet another object of the present invention is to provide a magnetic hanging device comprising a corrosion resistant coating such that the device can be used outdoors.

Another object of the present invention is to provide a magnetic hanging device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the magnetic hanging device.

FIG. 2 shows a side view of an embodiment of the magnetic hanging device.

FIG. 3 shows a view of magnetic hanging devices as used to support a strand of lights.

### DETAILED DESCRIPTION OF THE INVENTION

Reference is made herein to the attached drawings. Like reference numerals are used throughout the drawings to depict like or similar elements of the magnetic hanging device. For the purposes of presenting a brief and clear description of the present invention, the preferred embodiment will be discussed as used for providing a hanging device that can be removably secured to metallic objects and surfaces. The figures are intended for representative purposes only and should not be considered to be limiting in any respect.

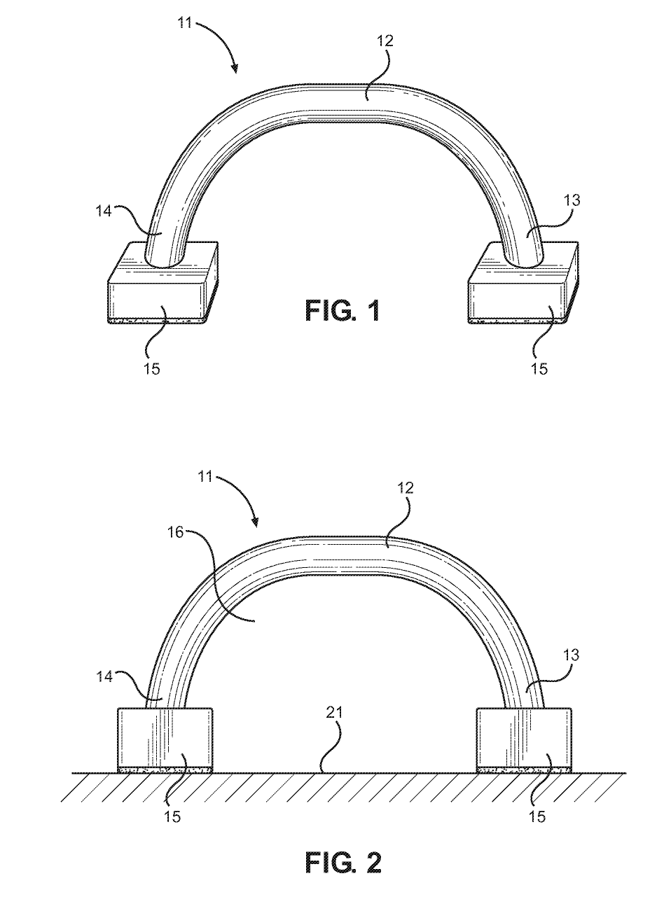

Referring now to FIGS. 1 and 2, there are shown views of an embodiment of the magnetic hanging device of the present invention. The magnetic hanging device 11 comprises an elongated rod 12 having a first end 13 and a second end 14. Each end 13, 14 includes a magnet 15 thereon for securement to a magnetic or metallic surface. The magnet 15 is preferably a permanent magnet. The magnets 15 can be composed of any of various suitable materials, such as neodymium. The magnets 15 are sufficiently strong such that the hanging device 11 will remain in a desired position on a support surface when an object is suspended therefrom.

The elongated rod 12 is preferably U-shaped such that the magnets 15 on the first end 13 and second end 14 can simultaneously be positioned against a substantially flat support surface 21. Once the magnets 15 are engaged with the support surface, the hanging device 11 is adapted to remain in the desired position until removed by the user. Thus, the magnets are sufficiently strong such that the weight of an object supported on the hanging device 11 will not dislodge the hanging device 11.

The elongated rod 12 is preferably curved or rounded. However, in alternate embodiments the elongated rod 12 includes linear sections connected at right angles. Further, the elongated rod 12 is preferably rigid so as to remain in a fixed position when the magnetic hanging device 11 is installed on a support surface. Alternatively, the elongated rod 12 is semi-rigid in some embodiments, such that the configuration of the elongated rod 12 can be adjusted as desired by the user.

The elongated rod 12 and magnets 15 are preferably covered by a layer of weatherproof material. The weatherproof material is adapted to prevent the magnetic hanging device 11 from becoming damaged by water or precipitation. Thus, the weatherproof material is preferably corrosion resistant. The weatherproof material may include a corrosion resistant coating, rubber, silicone, among other suitable materials. In some embodiments, 15 the magnets are not covered by a weatherproof material so that the magnets 15 can be fastened directly to a support surface.

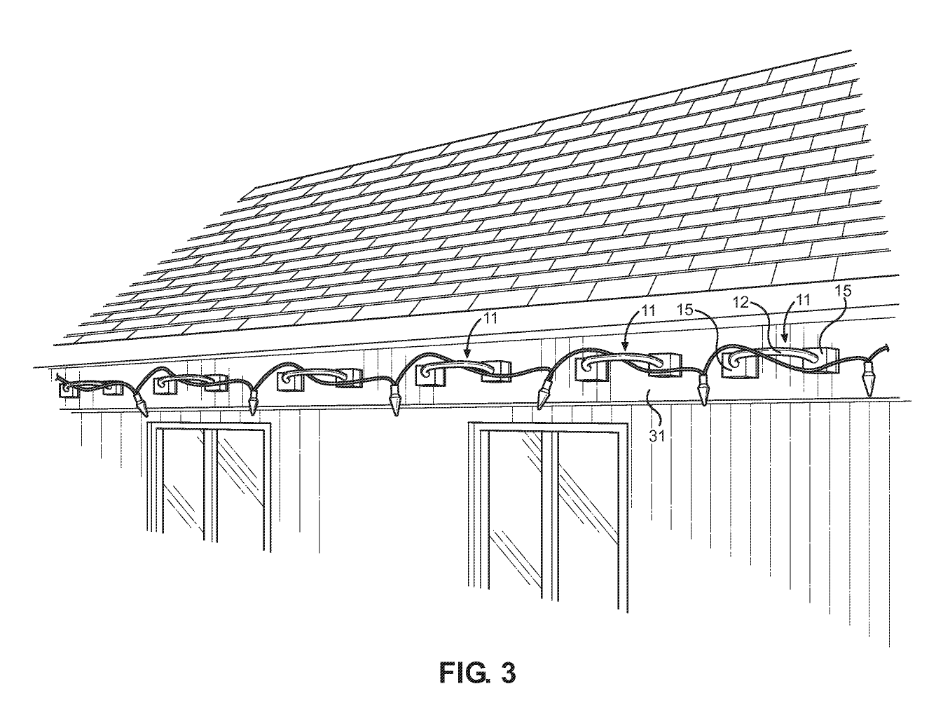

Referring now to FIG. 3, there is shown a view of magnetic hanging devices as used to support a strand of lights. In operation, one or more hanging devices 11 can be secured to a metallic or magnetic surface in order to suspend or hang objects and tools. In the illustrated embodiment, a plurality of hanging devices 11 are removably secured to the exterior of a rain gutter on a building in order to suspend a strand of decorative lights. Thus, the lights can be easily suspended by threading the strands through the hanging devices 11. The hanging devices 11 can be easily installed and removed without causing any damage to the rain gutters. Further, the hanging devices are weather resistant so that the hanging devices are not damaged from exposure to moisture or precipitation.

The hanging devices are versatile and can be used to suspend various objects from various surfaces. For example, the hanging devices can be positioned on the interior of a locker in order to suspend bags and clothing therefrom. Further, the hanging device can be secured to the exterior of a grill in order to suspend grill tools, such as tongs therefrom. Thus, the hanging device can be engaged with any metallic or magnetic surface in order to provide a hanging device that is easily installed and that does not damage the surface thereof.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A magnetic hanging device, comprising:
an elongated rod having a first end and a second end, wherein said elongated rod is adapted to support an object therein;
wherein said first end and said second end each include a magnet thereon, wherein said magnets can be removably magnetically engaged with a support surface.

2) The magnetic hanging device of claim 1, wherein said elongated rod comprises a U-shaped configuration.

3) The magnetic hanging device of claim 1, wherein said elongated rod is rigid.

4) The magnetic hanging device of claim 1, wherein said elongated rod is semi-rigid.

5) The magnetic hanging device of claim 1, wherein said elongated rod is coated with a corrosion resistant material.

6) The magnetic hanging device of claim 1, wherein said elongated rod and said magnets are coated with a corrosion resistant material.
